(19) United States
(12) Patent Application Publication
(10) Pub. No.: US 2005/0153118 A1
(43) Pub. Date: Jul. 14, 2005

(54) Production of pulp and materials utilizing pulp from fibrous proteins

(76) Inventor: Carlo Licata, Pasadena, CA (US)

Correspondence Address: CATALYST LAW GROUP, APC, 4330 LA JOLLA VILLAGE DRIVE SUITE 220, SAN DIEGO, CA, 92122, US

(21) Appl. No.: 10/939,222

(22) Filed: Sep. 10, 2004

Related U.S. Application Data
(60) Provisional application No. 60/501,958, filed on Sep. 10, 2003.

(51) Int. Cl. B32B 29/02

(52) U.S. Cl. 428/292.7

(57) ABSTRACT

A pulp material that comprises a fibrous protein fiber is suitable for incorporation into paper or paper composites. The fibrous protein of the fibrous protein fiber is typically a keratin, fibrin, collagen, or elastin. Preferably, the fibrous protein is a collagen, such as a β-keratin. The β-keratin can be obtained from avian feathers, such as chicken feathers. The pulp material can further comprise at least one additive such as mordants. dyes. binders. foaming agents. hardeners. chemical sizing agents, fillers. wetting agents. plant fibers, or animal fibers. The pulp material can be treated with a crosslinking agent or an oxidizing agent. Other aspects of the invention include a biodegradable polymer comprising the pulp material and a filter comprising the pulp material. Still another aspect of the invention is a composite material comprising: (1) the pulp material; and (2) a fiber selected from the group consisting of an animal fiber and a plant fiber. Still another aspect of the invention is a multilayer material comprising: (1) a first layer that is the pulp material; and (2) a second layer including a material selected from the group consisting of paper and a biopolymer.

### CROSS-REFERENCES

This application claims priority from Provisional Application Ser. No. 60/501,958 by Licata, entitled “Production of Pulp and Materials Utilizing Pulp from Fibrous Proteins,” filed Sep. 10, 2003, which is incorporated herein in its entirety by this reference.

### BACKGROUND OF THE INVENTION

The present invention generally relates to the production of pulps from fibrous proteins and to the production of materials and compositions utilizing those pulps.

Currently, feathers, such as feathers from poultry raised for eggs or food, are a waste product for which disposal is difficult. For example, the feathers can be hydrolyzed, then dried and ground to a powder to be used as a feed supplement for a variety of livestock, primarily chickens. This is an expensive process, however, and results in a protein product of low quality for which demand is low. Other disposal means such as burning or burying are also occasionally utilized. However, these measures are considered environmentally unsound and are therefore largely prohibited. They are at best temporary expedients and have high costs even if permitted.

Accordingly, there is a need for products that can utilize feathers for the production of a protein-based material that can be incorporated into a variety of useful products, such as papers, coatings, and other fibrous materials.

### SUMMARY OF THE INVENTION

One embodiment of the present invention is a pulp material comprising a fibrous protein fiber, the pulp material suitable for incorporation into paper or paper composites. The fibrous protein of the fibrous protein fiber is typically a keratin, fibrin, collagen, or elastin. Preferably, the fibrous protein is a collagen, such as a β-collagen. The β-collagen can be obtained from avian feathers, such as chicken feathers. The pulp material can further comprise at least one additive such as mordants, dyes, binders, foaming agents, hardeners, chemical sizing agents, fillers, wetting agents, plant fibers, or animal fibers. The pulp material can be treated with a crosslinking agent or an oxidizing agent.

Another embodiment of the present invention is a biodegradable polymer comprising the pulp material. The biodegradable polymer can include additives as described above and can be treated with a crosslinking agent or an oxidizing agent.

Another embodiment of the present invention is a filter comprising the pulp material. The filter can include additives as described above and can be treated with a crosslinking agent or an oxidizing agent.

Yet another embodiment of the present invention is a composite material comprising: (1) the pulp material; and (2) a fiber selected from the group consisting of an animal fiber and a plant fiber. The composite material can include additives as described above and can be treated with a crosslinking agent, an oxidizing agent, or a lipophilization agent.

Yet another embodiment of the present invention is a multilayer material comprising: (1) a first layer that is the pulp material; and (2) a second layer including a material selected from the group consisting of paper and a biopolymer. The multilayer material can include additives as described above and can be treated with a crosslinking agent, an oxidizing agent, or a lipophilization agent.

The fibrous protein of the fibrous protein fiber can be selected from the group consisting of keratins. collagens, fibrins, and elastins. Typically, the fibrous protein of the fibrous protein fiber is a keratin, such as an α-keratin or a β-keratin. Typically, the keratin is a naturally-occurring keratin and is unmodified.

Preferably, the keratin is a β-keratin and is obtained from avian feathers, such as from a chicken, a turkey, a duck, or a goose.

Alternatively, the keratin is selected from the group consisting of keratin proteins obtained from wool, eggshell membrane, silk, spider web, animal hair, human hair, animal nail, human nail, animal skin, and their components.

### BRIEF DESCRIPTION OF THE DRAWINGS

The following invention will become better understood with reference to the specification, appended claims, and accompanying drawings, where:

FIG. 1 is a scanning electron microscope (SEM) picture of keratin protein fibers.

FIG. 2 is a SEM picture of keratin protein fiber showing the porous network.

FIG. 3 is a high magnification SEM image of keratin protein fiber showing the nanosized pores.

FIG. 4 is an atomic force microscope (AFM) picture of keratin protein fibers showing the microstructural morphology.

FIG. 5 is a SEM image of keratin quill showing the organized structure.

FIG. 6 is a SEM image of keratin quill revealing the spacing of micropores.

FIG. 7 is a graph showing the zeta potential of finely ground keratin protein fiber in the presence of released calcium.

FIG. 8 is a diagram showing the structure of keratin protein fiber showing the multiple functionalities: (a) electrostatic interaction; (b) hydrogen bonding; (c) hydrophobic interactions; and (d) disulfide linkages.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

One aspect of the present invention is a pulp material comprising a fibrous protein fiber. The pulp material is suitable for incorporation into paper or paper composites as well as into other materials that can include fibers for strengthening or esthetic considerations.

Typically, the fibrous protein of the fibrous protein fiber is a keratin, a collagen, a fibrin, or an elastin. Preferably, the fibrous protein is a keratin.

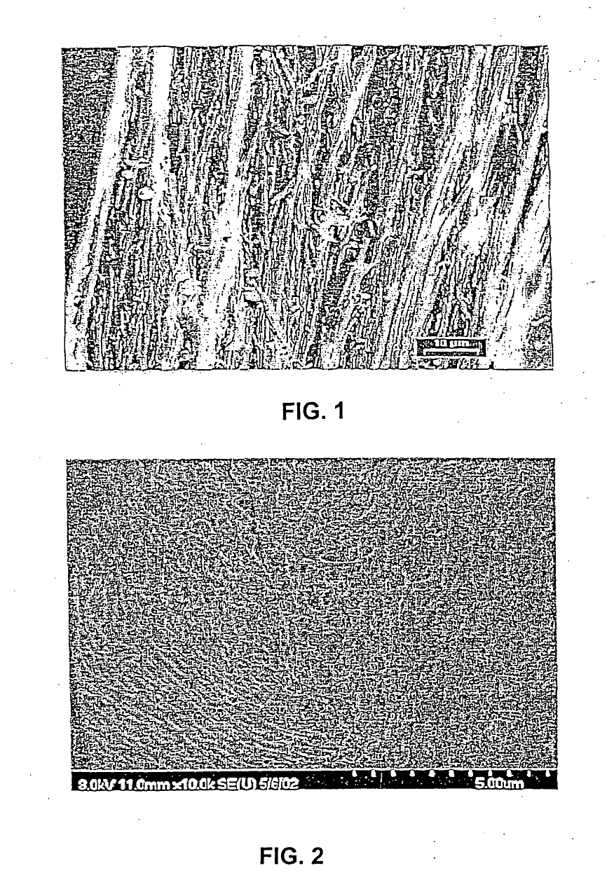

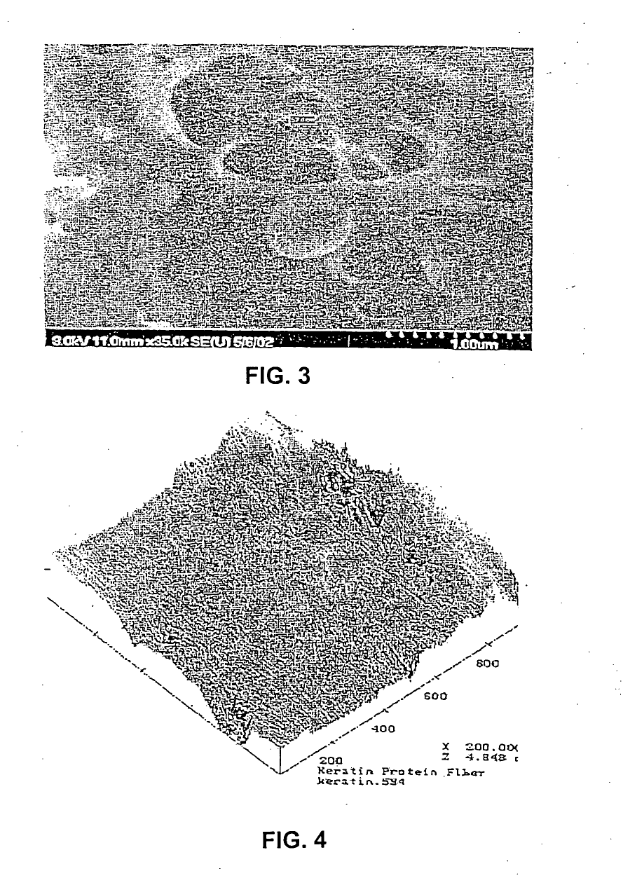

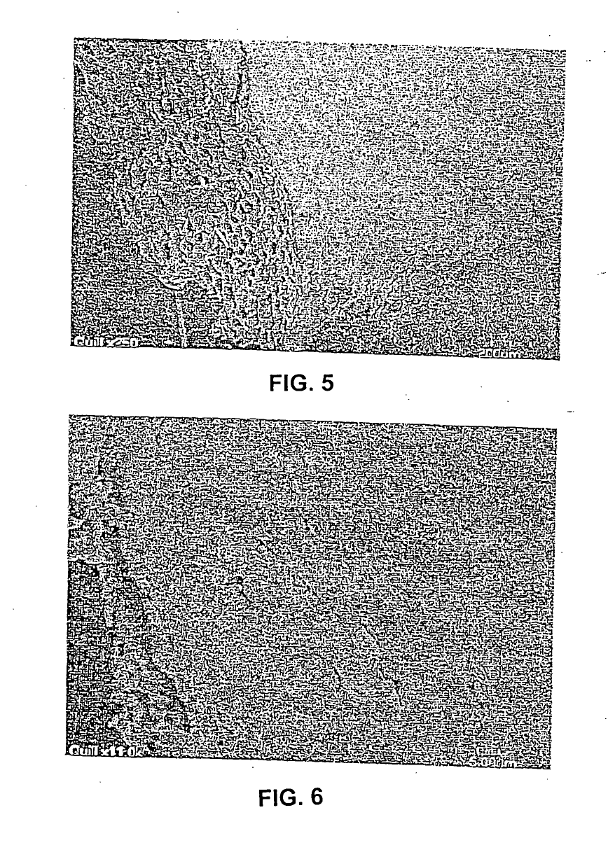

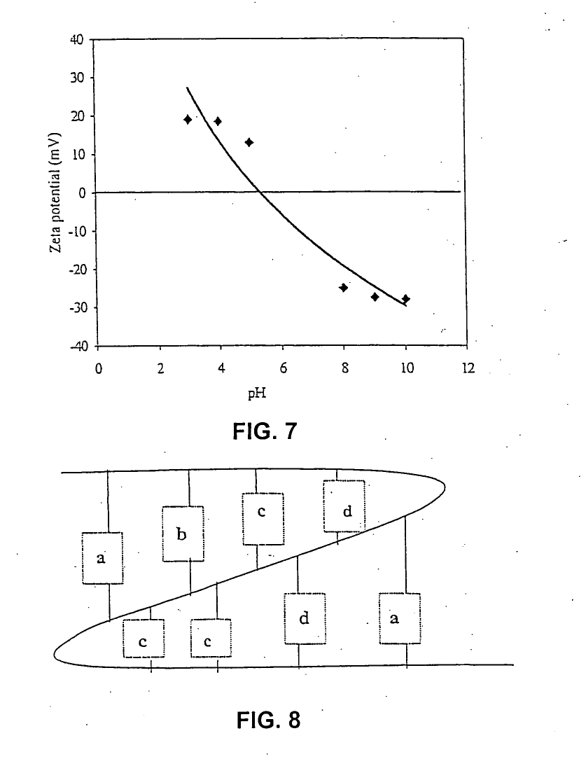

Keratin protein fibers have an intricate network of connective fibrous structure. A scanning electron microscope (SEM) picture of keratin protein fibers is shown in FIG. 1. The length of a single keratin fiber is approximately 200 microns and the maximum diameter of the fiber is 25 to 50 microns. The fiber fraction of the feather material has an organized microstructure and a nano-porous network with pores in the size range of 0.05 to 0.1 microns as shown in FIGS. 2 and 3. An atomic force microscope (AFM) picture of keratin protein fibers is shown in FIG. 4 and shows that the dimension of the fibers is in the nanoscale range. The high resolution AFM picture shows that each fiber is composed of numerous fine fibrous strands. Quill is hard and has an organized structure as shown in FIG. 5. However, the frequency of micropores (except in the detached cross-section) found in the fiber is indicated by FIG. 6. The surface area of keratin protein fiber, as determined by BET, is around 11 m2/g. Fourier Transform Infrared Spectroscopic (FTIR) analysis confirmed the presence of C—H (3076.065 cm⁻¹), COOH (1653.487 and 1637.178 cm⁻¹), N—H (1540.583 cm⁻¹), C—S (1075.980 and 1073.819 cm⁻¹) and S═S (617.715 cm⁻¹) groups in the keratin fibers. The zeta potential of the keratin fiber as a function of pH is shown in FIG. 7. At a pH above 5, the keratin protein is negatively charged, and at acidic pH it is positively charged. This behavior of keratin protein is due to the presence of various acidic and basic functional groups.

Amino acid analysis of the keratin fiber revealed a characteristic abundance of cysteine residues (7-20% of the total amino acid residues). These cysteine residues are oxidized to give inter- and intra-molecular disulfide bonds, which create the mechanically strong three-dimensionally linked network of keratin fiber. Each polypeptide chain in the feather keratin has a central helical section with a less regular region at each end. It has cross-linking hydrogen bonds formed between two parts of the protein chain that can be far apart. FIG. 8 illustrates schematically some of the functional groups present in the helical structure of the keratin protein and their resulting interactions: (a) electrostatic interactions; (b) hydrogen bonding; (c) hydrophobic interactions; and (d) disulfide linkages. These functional groups and the hollow fibrous structure contribute to the suitability of keratin as a pulp-forming material suitable for incorporation into paper and other materials, such as coatings, resins, and films.

As compared with starch thermoplastic hydrocolloids, proteins are heteropolymers. Another advantage of using proteins for film formation is that they can be involved in network structuring via the formation of high-energy and/or low-energy intermolecular bonds. Proteins, as discussed below, can undergo a wide variety of chemical modifications. Some of these proteins, particularly fibrous proteins, have a very high molecular weight and are markedly apolar or hydrophobic. These properties make fibrous proteins suitable for the formation of films and other coatings.

The complexity of proteins and the diversity of their functional groups are features that can be utilized to make films with original functional properties—differing substantially from those of conventional plastic materials. Protein-based materials are biodegradable and even edible when food-grade additives are used. They are also a priori biocompatible, apart from some protein-specific; characteristics that are not generally significant with fibrous proteins.

The moisture barrier properties of protein-based films are relatively poor (water permeability around 5×10.12 mol m⁻¹ S⁻¹ pa⁻¹) as compared to synthetic materials (0.05×10⁻¹² mol m⁻¹ S⁻¹ pa⁻¹ for low density polyethylene). However, this feature could be advantageous for packaging agricultural products. in films for agricultural uses, or cosmetic applications. These properties can be significantly improved for applications in which low water permeability is desired by incorporating fatty compounds such as beeswax or paraffin in the film formulation, thus reducing the water permeability. The mechanical properties of protein-based films have been measured and modeled. For the most resistant materials, such as films formed with wheat gluten, maize gluten, or myofibrillar proteins, critical fracture deformation (D_{c}=0.7 mm) and elastic modulus (K=510 Nm⁻¹) values are slightly lower than those of reference materials such as low density polyethylene (D_{c}=2.3 mm; K=135 Nm⁻¹), cellulose films (D_{c}=3.3 mm; K=350 Nm⁻¹), or even PVC (the properties of maize gluten-based films are close to those of PVC). The mechanical properties of films can be considerably enhanced by adding fibers to produce a composite material, as described below. The thermoplastic properties of proteins and their moisture resistance, particularly for insoluble proteins such as the fibrous proteins recited in the present invention, are particularly interesting for natural “resin” applications.

The gas barrier (O₂, CO₂, and ethylene) properties of protein-based films are highly interesting as they are exceptionally low under low relative humidity conditions. The permeability properties for O₂ (around 1 nmol m⁻¹ S⁻¹ pa⁻¹) are close to that of EVOH (ethylene-vinyl alcohol copolymer) (0.2 nmol m⁻¹ S⁻¹ pa⁻¹) and much lower than those for low density polyethylene (1000 nmol m⁻¹ S⁻¹ pa⁻¹). The gas barrier properties are closely dependent on the relative humidity and temperature. This effect is greater for hydrophilic gases (CO₂) than for hydrophobic gases (O₂) thus modifying the CO₂/O₂ selectivity coefficient, which can rise from 3 to more than 50 when the relative humidity increases from 0 to 100% and the temperature rises from 5 to 45° C. An assessment of modifications in the atmospheric composition around fresh mushrooms confirmed the high selectivity of this type of film; CO₂ and O₂ levels were around 1-2%, despite product respiration levels. Solute retention properties (especially antimicrobial and antioxidant agents) have been studied and modeled, thus paving the way for potential applications involving controlled release of beneficial agents for foods (e.g., active coating), agriculture (coated seeds), pharmacy (drug delivery) or cosmetics.

The thermoplastic characteristics of these protein raw materials have also been documented. The presence of water or plasticizers can lower the glass transition temperature (T_{g}) and enable processing at temperatures below those that lead to protein decomposition, which means that protein-based films can be formed by techniques that are conventionally used with synthetic polymers (extrusion, injection, molding, etc.). T_{g} levels of many protein raw materials (myofibrillar proteins, wheat gluten, maize gluten, etc.) have been determined according to the plasticizer content and the polar or apolar nature of the molecules (water, polyols, urea, amine compounds, fatty acids and derivatives, etc). The depressive effect of plasticizers on T_{g} is relatively well described by the Couchman-Karasz relation, as long as the system remains homogeneous (for temperatures above 0-10° C. Suitable plasticizers include, but are not limited to, ethylene glycol, propylene glycol, glycerol, and other polyols, urea, fatty acids, fatty acid derivatives, and aliphatic and aromatic amines.

Formation of a homogeneous malleable phase (plastification) with a wheat gluten (and maize gluten) film-forming solution, using different thermal (at temperatures above the T_{g}), mechanical (shear) and chemical (additives and degradation) treatments, was investigated on the basis of the viscoelastic and flow properties of malleable materials as a function of temperature, moisture content, and time. “Plasticized gluten” is similar to a structured viscoelastic solid with pseudoplastic behavior. The pseudoplastic index of plasticized gluten (m=0.27 to 0.37) is comparable to that of plasticized starch (m=0.32 to 0.37) and low density polyethylene (m=0.4). The consistency (k=18000 to 47000 Pa-s) is higher than that of low density polyethylene (k=9700 Pa-s) but close to that of plasticized starch (k=11000 to 40300 Pa-s).

These variables can be manipulated to produce films and other materials incorporating fibrous proteins according to the present invention with the desired properties, including plasticity, thermal resistance, water resistance, and ability to be formed into the desired physical configuration by standard techniques.

The combination of nano-fibrous structure and functional groups makes protein fibers an excellent biosorption material. Such protein fibers have the desirable properties recited above. These properties can be modified according to the desired use of the composition incorporating the protein fibers.

The structure and properties of keratin are described in D. Voet & J. G. Voet, “Biochemistry” (2d ed., John Wiley & Sons, New York, 1995), pp. 153-155, incorporated herein by this reference. Keratins are divided into two classes, α-keratins and β-keratins. The α-keratins are found in mammals, and the β-keratins are found in birds and reptiles.

Compositions according to the present invention can comprise keratins obtained from avian feathers, including poultry such as chicken, turkey, duck, and goose, and other commercially available poultry species, as well as feathers from other birds such as pigeons. Alternatively, methods according to the present invention can be performed with keratins obtained from other sources such as wool, egg shell membrane, silk, spider web, animal hair, human hair, animal nail, human nail, animal skin, human skin, or their components. As used herein, the term “keratin” includes both naturally-occurring keratin and keratin that has been modified by reactions such as acetylation, phosphorylation, hydroxylation, glycosylation, and other chemical reactions that can occur on the functional groups of the keratin proteins. As used herein, the term “keratin” further includes muteins of keratin that are produced by genetic engineering techniques well-known in the art, such as site-specific mutagenesis and fusion proteins that incorporate keratins, as long as such fibrous proteins remain fibrous. However, it is generally preferable to use naturally-occurring unmodified keratins in compositions according to the present invention.

Alternatively, compositions according to the present invention can comprise other fibrous proteins, either naturally-occurring fibrous proteins or chemically-modified or genetically-engineered fibrous proteins. Naturally-occurring fibrous proteins include, but are not limited to, fibroin, collagen, and elastin. Fibrous proteins are described in D. Voet & J. G. Voet, “Biochemistry” (2d ed., John Wiley & Sons, New York, 1995), pp. 153-162, incorporated herein by this reference.

Preferably, the keratin protein is from a feather, such as that of a chicken. More preferably, the keratin protein is from the fiber portion of the feather as compared to the quill portion. Thus, the keratin protein may be essentially only the fiber portion of a chicken feather that has been separated from the quill portion. What is meant by “essentially” is that the keratin protein is characterized by a fiber to quill weight ratio of at least about 1:1. The manner of preparing and then separating the fiber from the quill does not comprise a part of the present invention and may be accomplished by known methods such as that described in U.S. Pat. No. 5,705,030, incorporated herein by this reference.

The size of the keratin protein particles provided may vary from about 2 mm to 0.01 mm. Preferably, however, the size is between about 2 mm to 0.1 mm, and more preferably between about 1 mm to 0.1 mm.

The pulp material can further comprise water, casein, and a lower alcohol. Typically, the lower alcohol is one of methanol, ethanol, 1-propanol, or 2-propanol. Preferably, the lower alcohol is ethanol. A suitable casein preparation is a commercial casein glue such as Elmer's Glue (Borden Co., Columbus, Ohio). Other suitable casein preparations can be used.

The pulp material can further comprise other additives. Such additives can include, but are not necessarily limited to, mordants, dyes. binders, foaming agents, hardeners, chemical sizing agents, fillers, wetting agents, plant fibers, and animal fibers. Still other additives, including preservatives and antioxidants, can be used, and are known in the art.

Mordants are used to set the color when a natural dye is used. Suitable mordants include, but are not limited to, alum (aluminum potassium sulfate), copper sulfate, potassium dichromate, ferrous sulfate, sodium sulfate, tannin, tartaric acid, stannous chloride, calcium carbonate, and thiourea dioxide Other mordants are known in the art

Suitable dyes include, but are not necessarily limited to, metal oxides such as titanium dioxide and iron oxide. Other metal oxides are suitable as dyes and can be used. Other dyes are known in the art and can be used.

Suitable binders include, but are not necessarily limited to, starch and casein Other polymeric binders are suitable and can be used, such as cellulose, carboxymethylcellulose, hydroxymethylcellulose, and other modified celluloses. Other binders are known in the art and can be used.

Suitable chemical sizing agents include, but are not limited to, a ketene dimer emulsion. Other chemical sizing agents can be used.

In another alternative, the pulp material is treated with an oxidizing agent. Suitable oxidizing agents include, but are not limited to, hydrogen peroxide and other peroxides. Other oxidizing agents are known in the art.

In yet another alternative, the pulp material is treated with a crosslinking agent. Suitable crosslinking agents include, but are not limited to, formaldehyde, glyoxal, glutaraldehyde, N,N′-suberoyl glucosamine, N,N′-hexamethylene glucuronamide, and bis-1, 1-(1,8-octyl)glucofuranosidurono-6,3-lactone. Other crosslinking agents that can crosslink proteins are known in the art. Such cross-linking agents can react with functional groups in the protein including amino groups, hydroxyl groups, and carboxyl groups. Crosslinking agents can be classified as homobifunctional or heterobifunctional according to whether the particular crosslinking agent has the same functional group on both ends or different functional groups on both ends of the linker. Crosslinking agents are further described in S. S. Wong, “Chemistry of Protein Conjugation and Cross-Linking” (CRC Press, Boca Raton, 1993). The use of a crosslinking agent can improve the barrier and mechanical properties of films or sheets prepared from the pulp material

In still another alternative, the pulp material is treated with a lipophilization agent. Typically, the lipophilization agent is an acyl chloride of a medium-chain carboxylic acid with an even number of carbons, such as hexanoyl chloride, octanoyl chloride, and decanoyl chloride. The acyl chloride reacts with the pulp material by the Schotten-Baumann reaction. The use of a lipophilization agent can make films or sheets prepared from the pulp material more hydrophobic and resistant to water penetration. Other lipophilic agents are known in the art and can be used.

Fiber pulp slurry is adjusted to consistencies effective for extrusion or pressing and forming various shaped and sized objects such as trays, containers, vessels, tubes, frames, or masts. Fiber pulp can also be rolled and compressed into sheets and plates such as used for particle board Fiber pulp can also be combined with appropriate foaming agents to produce a variety of light weight filling materials for padding, packing, or insulation. Suitable foaming agents are known in the art and include, but are not limited to, detergents and surfactants such as nonionic detergents, anionic detergents, and cationic detergents.

The pulp can also be used for the preparation of fabrics, either woven or non-woven. The fibers can be strengthened by the addition of adhesives, binders, or sizing agents, and otherwise modified by the other additives described above such as dyes, mordants, whiteners, or redox reagents.

Another aspect of the present invention is a filter comprising pulp material according to the present invention, as described above. Fiber pulp can be used to manufacture selective filters or general adsorbents.

The filter can be in any of the conventional physical forms used for filters, such as sheets, pads, or cones. The porosity of the filter can be chosen so that the filter can be used to retain large particles, small particles, or colloids as desired.

The filter can be used together with other conventional filters, such as in tandem.

Yet another aspect of the present invention is a composite material comprising: (1) a pulp material of the present invention; and (2) a fiber that is an animal fiber or a plant fiber.

The animal fiber can be, but is not necessarily limited to, collagen. Other animal fibers can be used

The plant fiber can be, but is not necessarily limited to, one of kenaf, cotton rag, wood cellulose, coconut fiber, sisal fiber, or straw fiber. Other plant fibers can be used.

The relative proportions of the pulp material and the animal or plant fiber can be adjusted within broad limits depending on the desired properties of the composite material. For example, the pulp material can comprise from 30% to 70% of the composite material, with the animal or plant fiber comprising from 70% to 30% of the composite material. Values within this range are also possible and are within the scope of the invention.

The composite material can further comprise other ingredients as described above, including, but not limited to, mordants, dyes, binders, foaming agents, hardeners, chemical sizing agents, whiteners, fillers, wetting agents, plant fibers, and animal fibers. Suitable whiteners include, but are not limited to fluorescent whitening agents such as diaminostilbene sulfonate derivatives. Suitable fillers include, but are not limited to calcium carbonate, alumina, and other inorganic compositions. Suitable wetting agents include, but are not limited to detergents and surfactants, including non ionic surfactants, cationic surfactants, and anionic surfactants. The composite material can be treated with an oxidizing agent, a crosslinking agent, or a lipophilization agent, as described above

Still another aspect of the present invention is a multilayer material comprising: (1) a first layer including the pulp material; and (2) a second layer including a material selected from the group consisting of paper and a biopolymer.

When the second layer is paper, the thickness and porosity of the paper is chosen so that the composite material has the desired properties of stiffness, permeability, and moisture resistance. The relative thicknesses of the first and second layer can be adjusted as desired. For example, the first layer and the second layer can be of equal thickness. Alternatively I the second layer can be thicker than the first layer including the pulp material.

When the second layer is a biopolymer, it can be, but is not necessarily limited to, polylactic acid (PLA), a biopolyester, a starch-based polymer, casein formaldehyde, cellulose acetate, a pullulan, a chitin, a glycogen, a dextran, a protein-based polymer, and a polynucleotide-based polymer.

In the multilayer material, the first layer can further include other ingredients as described above, including, but not limited to, mordants, dyes, binders, foaming agents, hardeners, chemical sizing agents, whiteners, fillers, wetting agents, plant fibers, and animal fibers. The first layer of the multilayer material can be treated with an oxidizing agent, a crosslinking agent, or a lipophilization agent, as described above.

Still another aspect of the present invention is a film comprising a pulp material according to the present invention. The film can further comprise a lipophilic compound to reduce water permeability of the film. Suitable lipophilic compounds include, but are not limited to, paraffins and beeswax.

Materials comprising or constructed of pulp materials according to the present invention, particularly films, can be used as active coatings for foods, coatings for seeds, agents for drug delivery, such as for controlled release, and for cosmetic packaging and storage. In such uses, the properties of the materials, such as water permeability, can be chosen to suit the particular use and the particular material being coated or packaged.

When the fibrous protein is keratin, more preferably, the keratin protein is from the fiber portion of the feather as compared to the quill portion. Thus, the keratin protein may be essentially only the fiber portion of a chicken feather that has been separated from the quill portion. What is meant by “essentially” is that the keratin protein is characterized by a fiber to quill weight ratio of at least about 1:1. The manner of preparing and then separating the fiber from the quill does not comprise a part of the present invention and may be accomplished by known methods such as that described in U.S. Pat. No. 5,705,030, incorporated herein by this reference.

The size of the keratin protein particles provided may vary from about 2 mm to 0.01 mm. Preferably, however, the size is between about 2 mm to 0.1 mm, and more preferably between about 1 mm to 0.1 mm.

Existing techniques and technologies can be used to manufacture products from pulp materials according to the present invention. The procedures are well-known in the art, and the pulp fits into production schemes already known in the art, particularly for the preparation of paper products in various grades and types, such as printing grades, industrial grades, specialty grades, and tissue paper. Corrugated materials such as cardboard are made directly from paper products in existing corrugation machinery. These procedures are suitable for the production of products from composite and multilayer materials according to the present invention.

1. A pulp material comprising a fibrous protein fiber, the pulp material suitable for incorporation into paper or paper composites

2. The pulp material of claim 1 wherein the fibrous protein of the fibrous protein fiber is selected from the group consisting of keratins, collagens, fibrins, and elastins.

3. The pulp material of claim 2 wherein the fibrous protein is a keratin and the keratin is selected from the group consisting of α-keratins and β-keratins

4. The pulp material of claim 3 wherein the keratin is a β-keratin.

5. The pulp material of claim 4 wherein the β-keratin is obtained from avian feathers

6. The pulp material of claim 5 wherein the avian feathers are obtained from a species selected from the group consisting of a chicken, a turkey, a duck, and a goose.

7. The pulp material of claim 6 wherein the feathers are chicken feathers.

8. The pulp material of claim 1 wherein the pulp material further comprises at least one additive selected from the group consisting of mordants, dyes, binders, foaming agents, hardeners, chemical sizing agents, fillers, wetting agents, plant fibers, and animal fibers.

9. The pulp material of claim 1 wherein the pulp material is treated with an oxidizing agent.

10. The pulp material of claim 1 wherein the pulp material is treated with a crosslinking agent.

11. The pulp material of claim 1 further comprising a plasticizer in a quantity sufficient to reduce the T_{g} below a temperature leading to protein decomposition.

12. A biodegradable polymer comprising the pulp material of claim 1.

13. A filter comprising the pulp material of claim 1

14. A composite material comprising:
(a) the pulp material of claim 1; and
(b) a fiber selected from the group consisting of an animal fiber and a plant fiber.

15. A multilayer material comprising:
(a) a first layer including the pulp material of claim 1; and
(b) a second layer including a material selected from the group consisting of paper and a biopolymer.

16. A film comprising the pulp material of claim 1.

17. An active coating for food comprising the pulp material of claim 1.

18. A coating for a seed comprising the pulp material of claim 1

19. A controlled release agent for drug delivery comprising the pulp material of claim 1.

20. An agent for cosmetic packaging comprising the pulp material of claim 1.
